(19) United States
(12) Patent Application Publication
(10) Pub. No.: US 2002/0067742 A1
(43) Pub. Date: Jun. 6, 2002

(54) Management of WAP gateway through SNMP

(76) Inventors: Alexander Or, Nesher (IL); Arcady Chernyak, Rosh-HaAin (IL); Haim Rochberger, Tel-Mond (IL)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/729,234

(22) Filed: Dec. 5, 2000

(51) Int. Cl. H04J 11/00; H04J 3/16; H04J 3/22

(52) U.S. Cl. 370/466; 370/203

(57) ABSTRACT

A system and method for managing a WAP gateway through SNMP, by using a MIB. The MIB of the present invention contains a number of different details about the WAP gateway, and enables various operational parameters of the WAP gateway to be monitored and controlled.

### FIELD AND BACKGROUND OF THE INVENTION

The present invention is of a method and a system for managing a WAP (wireless application protocol) gateway through SNMP (Simple Network Management Protocol), and in particular, of such a system and method for management with SNMP in which the necessary details of the WAP gateway are stored in a MIB (Management Information Base).

Cellular telephones are becoming increasingly popular for portable telephone use, particularly for users who are interested in rapid, mobile data communication. As the amount of computational power and memory space which are available in such small, portable electronic devices becomes increased, a demand has arisen for different types of communication services through such devices. In particular, users have demanded that cellular telephones receive many different types of multimedia data, including e-mail (electronic mail) messages and Web pages.

In response to such demands, and to extend the power and efficacy of operation of portable, wireless electronic communication devices, the WAP (wireless application protocol) standard has been developed. WAP is now the standard for the presentation and delivery of wireless data, including multimedia and other information, and telephony services, on mobile telephones and other types of wireless communication devices. WAP is designed to efficiently provide both multimedia and telephony services to such wireless communication devices, given the limitations of wireless networks and of the electronic devices themselves. In particular, WAP is able to connect a cellular telephone to the Internet through a wireless network, such that the cellular telephone becomes another computational device on the Internet.

The WAP gateway is the most important element for building a network in order to access the Internet from a cellular telephone. The WAP gateway is required as a mediator and translator between the protocols and functionality of the Internet, and the protocols and functionality of the cellular telephone. In particular, the limitations of the cellular telephone in terms of both hardware components and capability of executing software result in a requirement for protocols which are adjusted for the cellular telephone, and which therefore differ from the protocols provided through the Internet. For example, the WAP protocol itself is binary, while Internet protocols are character-based. The WAP gateway must therefore be able to translate the WAP protocol to WML, which is XML compliant.

The corresponding WAP-based standards above define the functionality of WAP gateway in many respects, for example with regard to protocol translation, security, access authentication, operation with different types of basic communication protocols such as GSM, CDMA, TDMA and so forth. But none of these standards regulates management of WAP gateways, possible because most WAP gateway (translation) devices are implemented as a proxy server, which are usually not managed by SNMP. But, in order to support the amount of traffic which is required, a router is more suitable and more robust as infrastructure for the WAP gateway (translation) device. All routers are managed using SNMP, as these devices are part of the Internet infrastructure, and SNMP is a standard management tool for such infrastructure devices.

The best way to define the management system for Internet network devices such as routers or gateways is to define the specified Management Information Base (MIB) of that device according to Simple Network Management Protocol (SNMP, as described in RFC 1157, Simple Network Management Protocol (SNMP). J. D. Case, M. Fedor, M. L. Schoffstall, C. Davin. May 1, 1990). SNMP is a widely used mechanism to manage networks and network devices of different types. SNMP is a connectionless protocol, which is designed to operate over UDP (User Datagram Protocol, as described in RFC 768, J. Postel, August 1980). It is typically implemented with an agent process (or “SNMP agent”), which collects specific types of data and information about the network device which is being managed according to SNMP, and a management process for managing the network device. The local data is collected by the management process through the use of two commands: GET (and the corresponding command, GET-NEXT), which enables the management process to retrieve object values from the SNMP agent; and SET, which enables the management process to set these object values. In addition, the TRAP command enables the SNMP agent to report an event to the management process. The SNMP agent must also send a RESPONSE to the management process upon receiving one of the first two management process commands.

The collected data is then stored in a central database by the management process. The management process is then able to perform various actions and to collect and report the data according to a central MIB, which therefore enables network operators to manage and control the functions of each network device. The MIB actually defines the data which can be collected about the network according to SNMP. The MIB itself is structured like a tree, which the most general information available at the root of the tree, with more detailed information at each branch, and finally information about each network device is determined at a leaf or node of the MIB tree.

In particular, the use of the MIB enables the network operators to perform such functions as configuring network devices; determining the state of network devices; collecting and reviewing performance statistics of network devices; changing one or more important parameters, whether “on the fly” or on a non-realtime basis; and rebooting a network device which is exhibiting suspicious behavior. Of course other such functions would also be possible if WAP gateways could be managed by using SNMP with an associated MIB. Unfortunately, no standard exists for enabling WAP gateways to be managed with an MIB through SNMP.

There is therefore a need for, and it would be useful to have, a system and a method for managing and controlling the operation of WAP gateways and other WAP network devices through SNMP, by providing an associated MIB for the WAP gateway, thereby enabling the WAP gateway to be maintained and operated through a set of standard protocols which are shared by other types of network devices.

### SUMMARY OF THE INVENTION

The present invention is of a system and method for managing a WAP gateway and optionally other WAP network devices through SNMP, by using a MIB. The MIB of the present invention contains a number of different details about the WAP gateway, as described in greater detail below, and enables various operational parameters of the WAP gateway to be monitored and controlled.

The MIB according to the present invention is preferably based on the WAP standard 1.3 layered stack, and is based on features and/or elements which are required at that layer in the WAP standard. More preferably, the MIB is adjusted and/or altered as necessary in parallel to the WAP standard, so the MIB is able to provide management of the new features of the WAP standard.

According to the present invention, there is provided a system for managing a WAP gateway device, the WAP gateway device being connected to a network, the system comprising: (a) a management process for managing the network, the management process sending commands to the WAP device according to SNMP; (b) an SNMP agent at the WAP gateway device for receiving the commands; and (c) a local MIB for containing a plurality of commands for the WAP gateway device, the local MIB being located at the WAP gateway device, such that the SNMP agent sends a response to the management process according to the local MIB.

According to another embodiment of the present invention, there is provided a method for managing a WAP device through SNMP, the method comprising the steps of: (a) providing a MIB for containing a plurality of commands for interacting with the WAP device, the MIB being installed at the WAP device; (b) sending at least one command to the WAP device; (c) receiving a response from the WAP device according to an entry in the MIB; and (d) managing the WAP device according to the response.

Hereinafter, the term “wireless device” refers to any type of electronic device which permits data transmission through a wireless channel, for example through transmission of radio waves. Hereinafter, the term “cellular phone” is a wireless device designed for the transmission of voice data and/or other data, optionally through a connection to the PSTN (public switched telephone network) system.

Hereinafter, the term “network” refers to a connection between any two or more computational devices which permits the transmission of data.

Hereinafter, the term “computational device” includes, but is not limited to, personal computers (PC) having an operating system such as DOS, Windows™, OS/2™ or Linux; Macintosh™ computers; computers having JAVA™-OS as the operating system; graphical workstations such as the computers of Sun Microsystems™ and Silicon Graphics™, and other computers having some version of the UNIX operating system such as AIX™ or SOLARIS™ of Sun Microsystems™; Palm OS®; or any other known and available operating system, or any device, including but not limited to: laptops, hand-held computers, PDA (personal data assistant) devices, cellular telephones, any type of WAP (wireless application protocol) enabled device, wearable computers of any sort, which can be connected to a network as previously defined and which has an operating system. Hereinafter, the term “Windows™” includes but is not limited to Windows95™, Windows 3.X™ in which “x” is an integer such as “1”, Windows NT™, Windows98™, Windows CE™, Windows2000™, and any upgraded versions of these operating systems by Microsoft Corp. (USA).

For the implementation of the present invention, a software application could be written in substantially any suitable programming language, which could easily be selected by one of ordinary skill in the art. The programming language chosen should be compatible with the computing platform according to which the software application is executed. Examples of suitable programming languages include, but are not limited to, C, C++ and Java.

In addition, the present invention could also be implemented as firmware or hardware. Hereinafter, the term “firmware” is defined as any combination of software and hardware, such as software instructions permanently burnt onto a ROM (read-only memory) device. As hardware, the present invention could be implemented as substantially any type of chip or other electronic device capable of performing the functions described herein.

In any case, the present invention can be described as a plurality of instructions being executed by a data processor, in which the data processor is understood to be implemented according to whether the present invention is implemented as software, hardware or firmware.

### BRIEF DESCRIPTION OF THE DRAWINGS

The invention is herein described, by way of example only, with reference to the accompanying drawings, wherein:

FIG. 1 is a schematic block diagram showing an exemplary system according to the present invention for managing a WAP gateway through SNMP.

### DESCRIPTION OF THE PREFERRED EMBODIMENTS

The present invention is of a system and method for managing a WAP (Wireless Application Protocol) gateway, and optionally other WAP-enabled network devices, through SNMP (Simple Network Management Protocol), by using a MIB (management information base). The MIB of the present invention contains a number of different details about the WAP gateway, as described in greater detail below, and enables various operational parameters of the WAP gateway to be monitored and controlled. The present invention is particularly suitable for management and control of WAP network devices which act as translation gateways, for handling protocol translations between Internet protocols such as HTTP (HyperText Transfer Protocol) for example, and the corresponding WAP protocols such as WTP for example.

The MIB according to the present invention may optionally be used for any management purposes as for standard SNMP management of other network devices, such as routers for example. The MIB, which is used at the network device, is preferably implemented as an SNMP agent, which would more preferably be a component of the software for the WAP gateway (translation) device. Most preferably, the MIB would be provided in a standard supplied package as a plain text file. This text file must be compiled by any SNMP MIB compiler, after which it can be used as a management mechanism by using one of a number of commercial available MIB browsers. Examples of such MIB browsers include, but are not limited to, Netview-6000 (IBM Corp. USA), HP Open View (Hewlett-Packard Corp., USA), and SNMPC (Castle Rock Corp., USA)

The MIB of the present invention may optionally be implemented for management purposes on any WAP network, and particularly for WAP gateway and/or WAP translation devices, although the particularly preferred implementation according to the present invention is for a WAP gateway device for translation between WAP-based protocols and Internet-based protocols.

The MIB of the present invention is designed to be used in addition to the standard MIB-IL defined in RFC 1213 [K. McCloghrie, M. Rose, Management Information Base for Network Management of TCP/IP-based internets: MIB-II, March 1991]. The standard MIB-II must be supported for all devices based on TCP/IP. Therefore, since WAP is based on the IP datagram service, each WAP gateway must support the operation of the MIB-II, at least with regard to the main IP tables of this database, such as the tables for system parameters, interface table, ARP table, IP tables (for configuration and statistics), and UDP table. Thus, some of the parameters for the WAP gateway may be managed by this MIB-II, which is preferably recognized and used by the system and method of the present invention. Unfortunately, network devices, such as the WAP gateway (translation) and devices for providing access by mobile users to the Internet which are able to only use MIB-II have some major disadvantages. For example, MIB-II cannot reflect the dynamic character of the system, in which active users enter and leave the system. Also, MIB-II is not configurable according to specific WAP parameters. Furthermore, MIB-IL cannot show statistics related to such important issues as user authentication and accounting, the functionality of the WAP gateway through any kind of proxy and so forth. Also, MIB-II does not provide statistics through a basic configuration on different aspects of security issues.

One additional significant drawback of the ability to use only MIB-II functions is that these functions are provided only in order to be able to comply with the standard for IP datagrams. Therefore, current WAP implementations do not provide sufficient support for management of the WAP gateway through MIB-II, as the functionality which is supported does not enable independent management of the gateway through SNMP.

Generally, the main WAP gateway functions can be defined as follows: WAP translation; WAP security; WAP rerouting; WAP user access over RADIUS protocol; and network characteristics and parameters. Of these functions, the last set, network parameters and characteristics, may optionally be managed by standard MIB-II.

In order to provide extended functionality and greater control over the management of the WAP gateway and the functions thereof, the MIB of the present invention has additional components and therefore more comprehensive management functions. The proposed MIB configuration according to the present invention features the following components: WAP configuration; WAP statistics; WAP security configuration; and WAP security statistics.

Since any SNMP MIB is built as a tree, and all definitions of the current invention are preferably constructed as a full sub-tree of the MIB, the point (node tree) at which the sub-tree of the present invention is to be connected to the existing MIB should therefore also preferably be defined. More preferably, this point is chosen to be the node “wapForum”, which is defined as “enterprises.7777”, where instead of “7777”, a WAP Forum number from IANA (Internet Assigned Numbers Authority international organization) must be so defined and ordered. The “enterprises” node is defined in standard MIB-II on ASN-1 standard transcription as:

iso(1).org(3).dod(6).internet(1).private(4).enterprises(1). Of course, another insertion point to the standard MIB-II could alternatively be selected.

The principles and operation of a method and a system according to the present invention may be better understood with reference to the drawings and the accompanying description.

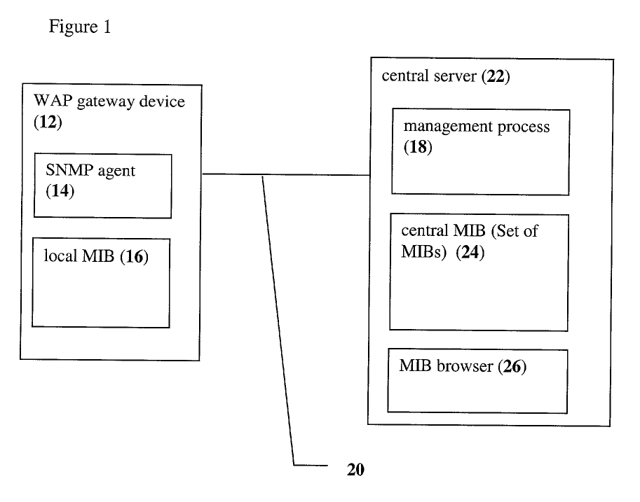

Referring now to the drawings, FIG. 1 shows an exemplary implementation of a system 10 according to the present invention for managing a WAP gateway through SNMP. System 10 features a WAP device 12, for which a non-limiting example is a WAP gateway, more preferably a WAP gateway device for translation, although of course any other WAP gateway device could be substituted for WAP device 12. WAP device 12 operates an SNMP agent 14 based on the standard TCP/IP stack in part of UDP, which may optionally be implemented as a software component, although of course other implementations are possible under the present invention. SNMP agent 14 has an associated local MIB 16, which is optionally and more preferably provided as a plaintext file. Local MIB 16, along with SNMP agent 14, are provided through the present invention. These two components enable the following functions of WAP gateway device 12 to be managed as a network device: WAP configuration; WAP statistics; WAP security configuration; user functions; and WAP security statistics.

The functions of WAP device 12 are determined according to the components of the WAP architecture, which is described in “Wireless Application Protocol Architecture Specification” (version of Apr. 30, 1998; incorporated herein by reference, available at http://www.wapforum.org). Certain features of this architecture are described with regard to the functions of local MIB 16 according to the present invention, for demonstrating some of the new features of local MIB 16 which clearly differentiate the MIB according to the present invention from currently available background art MIB's. An example of the MIB itself is given in the Appendix, at the end of the specification.

The seven layers of the WAP architecture include the lowest level layer, the transport layer (WDP, Wireless Datagram Protocol), which operates above the data transport services provided by the network. It is equivalent to UDP (User Datagram Protocol) for the Internet protocols. Local MIB 16 contains definitions and information related to UDP and to equivalent connections which are to be made at this level to WAP device 12. For example, the command:

wfConnType OBJECT-TYPE

SYNTAX WFConnType

ACCESS read-only

STATUS mandatory

DESCRIPTION

“Type of the existing connection: connection oriented (TCP)-WAP,

or connection-less (UDP)-transparent, or undefined.”

::={wfConnectionEntry 1 }

gives information related to the type of the existing connection to WAP device 12. For example, such a connection could optionally be made by an additional network device (not shown).

Above this lowest layer is the security layer (WTLS, Wireless Transport Layer Security), which is a security protocol based on the standard Transport Layer Security (TLS) protocol. Local MIB 16 contains definitions and information related to security of WAP device 12, as previously mentioned, and can also optionally and preferably be used for management of security functions. For example, the human network operator could select a particular security scheme, according to which WAP device 12 is permitted to communicate with other network devices (not shown). Such a security scheme would then be stored in local MIB 16. The information related to this scheme would be retrieved during a handshake procedure between WAP device 12 and another network device, such as a client WAP-enabled cellular telephone (not shown). WAP device 12 would then preferably inform the other network device of the predetermined scheme during the handshake procedure, such that communication between WAP device 12 and the other network device would preferably be performed according to the predetermined security scheme as stored in local MIB 16.

As a specific example of a security-related instruction, the command:

wfSecurityWtlsEnable OBJECT-TYPE

SYNTAX EnableDisableType

ACCESS read-write

STATUS mandatory

DESCRIPTION

“Enable Wireless Transport Layer Security (WTLS)

connections in WAP translation unit.”

DEFVAL {disable }

::={wfWtlsConfig 1 }

determines whether connections according to a particular secure protocol should be permitted for WAP device 12.

The above examples concern different illustrative functions of local MIB 16 with regard to exemplary WAP-related features and functions, as previously described. In addition, local MIB 16 also contains commands and information related to users. One example of such a command is as follows:

wfActiveUsersNumber OBJECT-TYPE

SYNTAX Counter

ACCESS read-only

STATUS mandatory

DESCRIPTION

“Number of currently active users.”

::={wfStatCommonUser 5 }

which, as shown above, gives the number of currently active users for WAP device 12.

Optionally, if the client WAP-enabled cellular telephone has a particular limitation or other characteristic, WAP device 12 can retrieve one or more instructions for handling such a limitation and/or other characteristic from local MIB 16, such that the interaction between WAP device 12 and the client WAP-enabled cellular telephone and/or other network device can preferably be optimized according to information stored in local MIB 16. This preferred embodiment has the advantage of enabling different types and/or brands of client WAP-enabled cellular telephones to be correctly handled by WAP device 12 according to the specific instructions of local MIB 16. Such a requirement for handling these different types of network devices further differentiates local MIB 16 from background art MIB implementations, which are not required to handle such different types of WAP-enabled devices.

Additional detailed examples of specific features of local MIB 16 are provided below.

WAP device 12 is in communication with a management process 18 through a network 20. Typically, management process 18 is operated by a central server 22, through which management services are provided to a plurality of WAP devices 12 (not shown). Management process 18 more preferably controls a set of MIB's, preferably including central MIB 24 according to the background art. Management process 18 also preferably supports a MIB browser 26, according to the background art, for enabling a human network operator to manage system 10 including WAP device 12.

For example, management process 18 is able to send the “GET” command to WAP device 12, and more specifically to SNMP agent 14, in order to retrieve information about the operation of WAP device 12. The response of SNMP agent 14 is determined according to local MIB 16. The portion of local MIB 16 which is particularly relevant to the present invention is preferably contained in a sub-tree of the standard MIB, specified for WAP devices and in particular for WAP gateway (translation) devices.

Examples of the commands available through local MIB 16 include commands for determining which version of WAP is being supported by local MIB 16, as follows:

wfSupportedVersion OBJECT-TYPE

SYNTAX WapSupportedVersion

ACCESS read-only

STATUS mandatory

DESCRIPTION

“The WAP version supported in translation.

Now WAP translation may be done for WAP version 1.1.

The WAP translation unit supports translation for

WAP version 1.1”

::={wfConfigCommon 1 }

A general command, which is useful for determining the size of the buffer provided for WAP devices, particularly for translation devices, is given as follows:

wfBufferTranslateSize OBJECT-TYPE

SYNTAX INTEGER (4096..65535)

ACCESS read-write

STATUS mandatory

DESCRIPTION

“Size of buffer that used for WAP translation.

Must be large enough to contain as WAP packet of maximum size as HTTP packet of maximum size.

Currently must be larger than 4096 and less than 65536 bytes.

Have to be set in compliance with system memory requirements.”

::={wfConfigCommon 4 }

A more specific command, which is useful for determining the WAP homepage for a particular brand of cellular telephone (which could not otherwise have such a determined homepage), is given as follows:

wfDefaultHomepage OBJECT-TYPE

SYNTAX DisplayString (SIZE (l..255))

ACCESS read-write

STATUS mandatory

DESCRIPTION

“Limitations of the Motorola WAP phone do not allow setting of a default homepage, therefore this parameter allows you to set the Motorola Timeport homepage URL.”

::={wfConfigCommon 2 }

Thus, clearly these different commands and types of information from local MIB 16 enable the human network operator to manage and control the behavior of WAP device 12, and through WAP device 12, to manage the overall behavior of network 20.

It will be appreciated that the above descriptions are intended only to serve as examples, and that many other embodiments are possible within the spirit and the scope of the present invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A system for managing a WAP device, the WAP device being connected to a network, the system comprising:
(a) a management process for managing the network, said management process sending commands to the WAP device according to SNMP;
(b) an SNMP agent at the WAP device for receiving said commands; and
(c) a local MIB for containing a plurality of commands for the WAP device, said local MIB being located at the WAP device, such that said SNMP agent sends a response to said management process according to said local MIB.

2. The system of claim 1, wherein the WAP device is a WAP gateway.

3. The system of claim 2, further comprising:
(d) a MIB browser for interacting with a human operator for managing the WAP gateway device, said MIB browser being operated by said management process.

4. The system of claim 2, wherein said WAP gateway performs translation of data between WAP-based protocols and Internet protocols.

5. The system of claim 4, wherein at least one command at said local MIB is for configuration of the WAP device.

6. The system of claim 4, wherein at least one command at said local MIB is for management of security of the WAP device.

7. The system of claim 4, further comprising at least one additional network device for connecting to the WAP device, wherein at least one command at said local MIB is for management of a connection to the WAP device by said network device.

8. A method for managing a WAP device through SNMP, the method comprising the steps of:
(a) providing a MIB for containing a plurality of commands for interacting with the WAP device, said MIB being installed at the WAP device;
(b) sending at least one command to the WAP device;
(c) receiving a response from the WAP device according to an entry in said MIB; and
(d) managing the WAP device according to said response.
